(19) United States
(12) Patent Application Publication
(10) Pub. No.: US 2020/0096899 A1
(43) Pub. Date: Mar. 26, 2020

(54) IMAGE FORMING APPARATUS

(71) Applicant: CANON KABUSHIKI KAISHA, Tokyo (JP)

(72) Inventors: Michihiro Yoshida, Nagareyama-shi (JP); Masahiro Makino, Tsukubamirai-shi (JP); Tadashi Fukuda, Tokyo (JP); Mikihiro Akasaki, Matsudo-shi (JP); Keisuke Kinai, Tokyo (JP)

(21) Appl. No.: 16/580,081

(22) Filed: Sep. 24, 2019

(30) Foreign Application Priority Data
Sep. 26, 2018 (JP) 2018-179900

(51) Int. Cl. G03G 15/08; G03G 9/087

(52) U.S. Cl. CPC G03G 15/0818; G03G 9/08757; G03G 9/08797; G03G 15/0808

(57) ABSTRACT

An image forming apparatus includes a photosensitive member, a charging roller, an image forming portion. The charging roller includes an electroconductive rubber layer and is 20 μm or more and 35 μm or less in ten point average roughness of a surface thereof and 130 μm or more and 250 μm or less in average interval of surface unevenness.

### FIELD OF THE INVENTION AND RELATED ART

The present invention relates to an image forming apparatus, such as a printer, a copying machine, a facsimile machine or a multi-function machine, using electrophotography.

In the image forming apparatus of an electrographic type, an electrostatic latent image is formed, by an exposure device, on a photosensitive drum electrically charged to a target charge potential by a charging device, and then this electrostatic latent image is developed into a toner image by a developing device. As the photosensitive drum, an organic photosensitive member including a single photosensitive layer containing a charge generating agent, a charge transporting agent and a binder resin material in the same layer is used (Japanese Laid-Open Patent Application 2012-014141). As the charging device, a charging roller electrically charging the photosensitive drum in contact with the photosensitive drum is used. Further, a DC charging type in which electric discharge is generated in a gap between the photosensitive drum and the charging roller by applying only a DC voltage to the charging roller and thus the photosensitive drum is charged is employed.

However, in the case where the photosensitive drum is the above-described organic photosensitive member including the single photosensitive layer, conventionally, a thin density non-uniformity in a lateral stripe shape extending in a main scan direction (a rotational axis direction of the photosensitive drum) occurred in an image in some instances. This is because on a downstream side of the photosensitive drum with respect to a rotational direction, due to electric discharge generating in a charging gap between the photosensitive drum and the charging roller (hereinafter, referred to as downstream side discharge), a part of the photosensitive drum charged by the electric discharge on an upstream side with respect to the rotational direction is electrically recharged.

### SUMMARY OF THE INVENTION

A principal object of the present invention is to provide an image forming apparatus improved in charging stability in a constitution in which a photosensitive drum including a single photosensitive layer is electrically charged by applying only a DC voltage to the photosensitive drum.

According to an aspect of the present invention, there is provided an image forming apparatus comprising: a photosensitive member including a substrate and a single photosensitive layer formed on the substrate and containing a charge generating agent, a charge transporting agent and a binder resin material; a charging roller configured to electrically charge the photosensitive member in contact with the photosensitive member under application of only a DC voltage; and an image forming portion configured to form an electrostatic latent image on the photosensitive member charged by the charging roller and then to form a toner image on a recording material on the basis of the formed electrostatic latent image, wherein the charging roller includes an electroconductive rubber layer and is 20 μm or more and 35 μm or less in ten point average roughness of a surface thereof and 130 μm or more and 250 μm or less in average interval of surface unevenness.

Further features of the present invention will become apparent from the following description of exemplary embodiments with reference to the attached drawings.

### BRIEF DESCRIPTION OF THE DRAWINGS

FIG. 1 is a schematic view showing a structure of an image forming apparatus of an embodiment of the present invention.

FIG. 2 is a sectional view showing a developing device.

FIG. 3 is a sectional view showing a photosensitive drum.

FIG. 4 is a graph showing a relationship between a surface shape and a charge potential of the charging roller.

### DESCRIPTION OF EMBODIMENTS

### <Image Forming Apparatus>

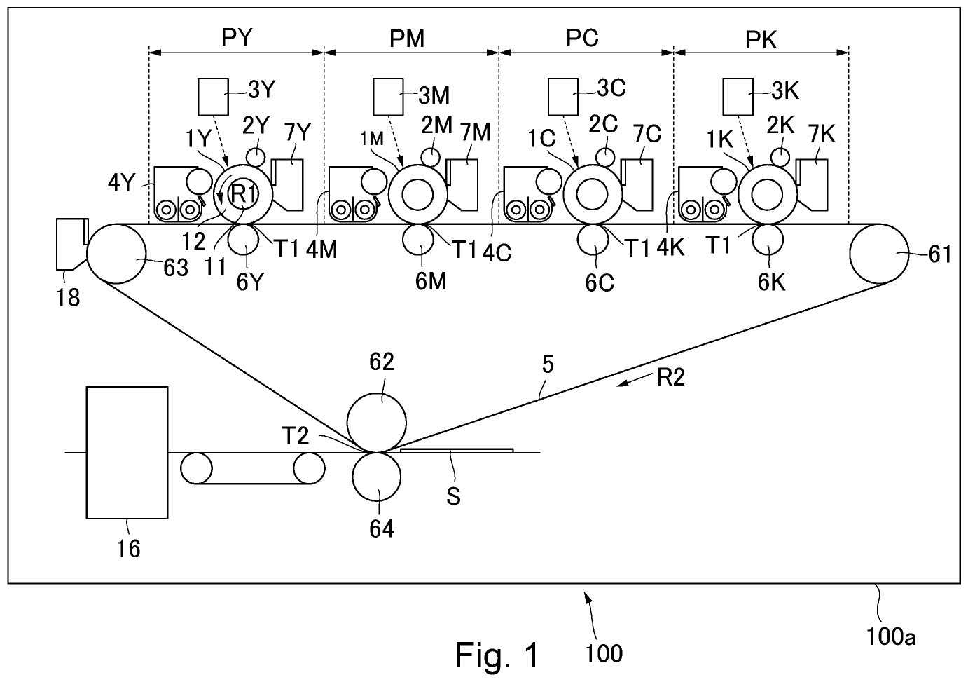

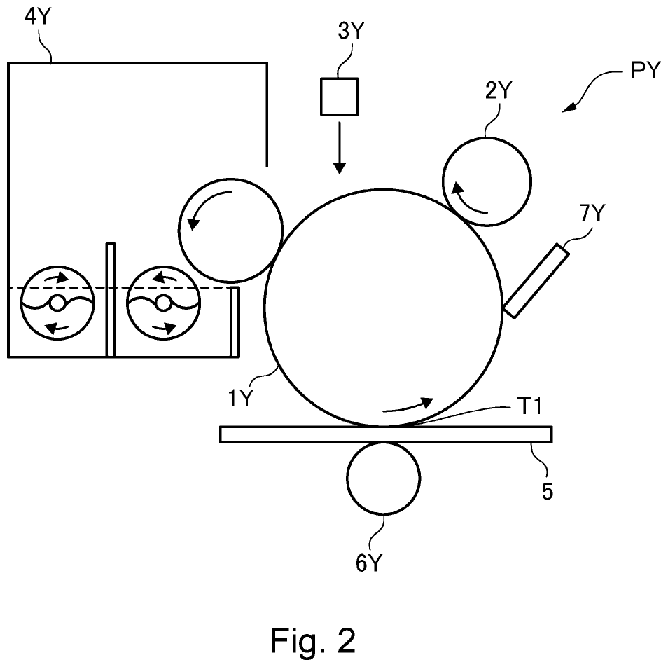

A structure of an image forming apparatus of this embodiment will be described with reference to FIGS. 1 and 2. An image forming apparatus 100 shown in FIG. 1 is full-color printer of a tandem type in which image forming portions PY, PM, PC and PK for yellow, magenta, cyan and black are arranged along an intermediary transfer belt 25.

At the image forming portion PY, a yellow toner image is formed on a photosensitive drum 1Y and then is transferred onto the intermediary transfer belt 5. At the image forming portion PM, a magenta toner image is formed on a photosensitive drum 1M and then is transferred onto the intermediary transfer belt 5. At the image forming portion PC and PK, cyan and black toner images are formed on photosensitive drums 1C and 1K respectively, and then are transferred onto the intermediary transfer belt 5. The four color toner images transferred on the intermediary transfer belt 5 are fed with movement of the intermediary transfer belt 5 to a secondary transfer portion T2 and are secondary-transferred onto a recording material S (sheet material such as a sheet or an OHP sheet). The recording material S is taken out one by one from an unshown feeding cassette and then is fed to the secondary transfer portion T2.

The image forming portions PY, PM, PC and PK have the substantially same constitution except that colors of toners used in developing devices 4Y, 4M, 4C and 4K, respectively, are yellow, magenta, cyan and black, respectively. Therefore, in the following, as a representative, the image forming portion PY for yellow will be described as an example, and other image forming portions PM, PC and PK will be omitted from description.

As shown in FIG. 2, the image forming portion PY includes, at a periphery of the photosensitive drum 1Y as an image bearing member, a charging roller 2Y, an exposure device 3Y, the developing device 4Y, a transfer roller 6Y and a drum cleaning blade 7Y are provided. The photosensitive drum 1Y is prepared by forming a photosensitive layer on an electroconductive substrate, and is rotated in an arrow R1 direction in FIG. 1 at a predetermined process speed (for example, 120 mm/s). The charging roller 2Y electrically charges the photosensitive drum 1Y to a uniform positive dark-portion potential under application of a DC charging voltage. In the case of this embodiment, only a DC voltage of “+1000 V to +1200 V” is applied to the charging roller 2Y by an unshown voltage source so that a surface potential of the photosensitive drum 1Y is “+400 V”. The charging roller 2Y is rotated at the substantially same rotational speed as that of the photosensitive drum 1Y. In the case of this embodiment, the photosensitive drum 1Y and the charging roller 2Y are capable of being rotated by lowering the rotational speed, for example, during sheet passing of thick paper more than during sheet passing of plain paper. The photosensitive drum 1Y and the charging roller 2Y will be specifically described later.

The exposure device 3Y generates a laser beam, from a laser beam emitting element, obtained by subjecting scanning line image data which is developed from an associated color component image to ON-OFF modulation and then to scanning through a rotating mirror, so that an electrostatic latent image for an image is formed on the surface of the charged photosensitive drum 1Y. The developing device 4Y supplies the toner to the photosensitive drum 1Y and develops the electrostatic latent image into the toner image. In the case of this embodiment, as the toner, toner particles of about 4-6 μm in average particle size are used.

The transfer roller 6Y is disposed opposed to the photosensitive drum 1Y while sandwiching the intermediary transfer belt 5 therebetween and forms a toner image primary transfer portion T1 between the photosensitive drum 1Y and the intermediary transfer belt 5. By applying a primary transfer voltage from an unshown voltage source to the primary transfer roller 6Y at the primary transfer portion T1, the toner image is primary-transferred from the photosensitive drum 1Y onto the intermediary transfer belt 5. The cleaning blade 7Y removes the toner remaining on the photosensitive drum 1Y after the primary transfer.

Returning to FIG. 1, the intermediary transfer belt 5 is extended around and supported by a tension roller 61, an inner secondary transfer roller 62, a driving roller 63 and the like, and is driven by the driving roller 63, so that the intermediary transfer belt 5 is rotated in an arrow R2 direction in FIG. 1. In this embodiment, a belt which possesses features of 10¹⁰ Ω·cm in volume resistivity ρv and 10⁸ Ω in surface resistivity ρs and which is made of polyether ether ketone was used. Incidentally, the volume resistivity ρv of the intermediary transfer belt 5 may preferably be 10⁸ Ω·cm-10¹² Ω·cm, and the surface resistivity ρs of the intermediary transfer belt 5 may preferably be 10⁸ Ω to 10¹³ Ω. As a material of the intermediary transfer belt 5, polyether ether ketone and polyimide are used in general.

The secondary transfer portion T2 is a toner image transfer nip, where the toner image is transferred onto a recording material S, formed by contact of the inner secondary transfer roller 62 with the intermediary transfer belt 5 supported by an outer secondary transfer roller 64. At the secondary transfer portion T2, by applying a secondary transfer voltage to the inner secondary transfer roller 62, the toner image is secondary-transferred from the intermediary transfer belt 5 onto the recording material S. The toner remaining on the intermediary transfer belt 5 after the secondary transfer is removed by a belt cleaning device 18.

The recording material S on which the toner image is secondary-transferred at the secondary transfer portion T2 is fed to a fixing device 16. The fixing device 16 fixes the toner image on the recording material S under application of pressure by rollers or belts or the like which oppose each other and under application of heat by a heat source such as a heater although those members are omitted from illustration. The recording material S on which the toner image is fixed by the fixing device 16 is discharged to an outside of the image forming apparatus 100.

### <Photosensitive Drum>

Next, the photosensitive drum 1Y will be described. In the case of this embodiment, the photosensitive drum 1Y is a cylindrical organic photosensitive member, and as shown in FIG. 1, includes an electroconductive substrate 11 and a photosensitive layer 12. The photosensitive layer 12 is a single layer photosensitive member containing a charge generating agent, a charge transporting agent and a binder resin material in the same layer. Incidentally, the photosensitive drum 1Y may further include layers (an intermediary layer, a protective layer and the like) other than the electroconductive substrate 11 and the photosensitive layer 12. As the binder resin material contained in the photosensitive layer 12, a resin material of 9% or more and 29% or less in deformation at yield. Further, the surface of the photosensitive drum 1Y may also be abraded or the like so that a ten point average roughness Rz (JIS roughness standard B0601 ('82)) is “0.2 μm or more and 2.0 μm or less”.

As the electroconductive substrate 11, a substrate having at least a surface constituted by, for example, an electroconductive material and the like substrate are cited. Specifically, the electroconductive substrate 11 may also be made of an electroconductive material, such as metal or the like, as a whole or may also be prepared by coating the electroconductive material on a surface of a non-electroconductive member formed of plastic or the like. As the electroconductive material, it is possible to cite, for example, aluminum, iron, copper, tin, platinum, silver, vanadium, molybdenum, chromium, cadmium, titanium, nickel, palladium, indium, stainless steel, brass and the like.

As described above, in the photosensitive layer 12, the charge generating agent, the charge transporting agent and the binder resin material and the like are contained. The charge generating agent, the charge transporting agent and the binder resin material and the like are not particularly limited, but for example, those shown below are used, for example.

As the charge generating agent, it is possible to cite powder of inorganic photoconductive materials such as X-type phthalocyanine (X-HZPc), Y-type oxotitanyl phthalocyanine (Y-TiOPc), perylene pigment, bisazo pigment, dithioketo-pyrrolopyrrole pigment, metal-free phthalocyanine pigment, metal naphthalocyanine pigment, squaraine pigment, trisazo pigment, indigo pigment, azulenium pigment, cyanine pigment, selenium, selenium-tellurium, selenium-arsenic, cadmium sulfide, amorphous silicon and the like; pyrylium salt; anthanthrone pigments; triphenylmethane pigments; threne pigments; toluidine pigments; pyrazoline pigments; quinacridone pigments; and the like.

As the charge transporting agent, it is possible to cite a hole transporting agent and an electron transporting agent is general. As the hole transporting agent, it is possible to cite benzidine derivatives, oxadiazole compounds such as 2,5-di( 4-methylaminophenol)-1,3,4-oxadiazole, styryl compounds such as 9-( 4-diethylaminostyryl)anthracene, carbazole compounds such as polyvinyl carbazole, organopolysilane compounds, pyrazoline compounds such as 1-phenyl-3-(p-dimethylaminophenyl)pyrazoline, and nitrogen-containing ring compounds and fused polycyclic compounds, such as hydrazole compounds, triphenylamine compounds, indole compounds, oxazole compounds, isoxazole compounds, thiazole compounds, thiadiazole compounds, imidazole compounds, pyrazole compounds, and triazole compounds and the like.

As the electron transporting agent, it is possible to cite quinone derivatives such as naphthoquinone derivatives, diphenylquinone derivatives, anthraquinone derivatives, azoquinone derivatives, nitroanthraquinone derivatives, and dinitroanthraquinone derivatives; malononitrile derivatives; thiopyrane derivatives; trinitrothioxanthone derivatives; 3,4,5,7-tetranitro-9-fluorenone derivatives; dinitroanthracene derivatives; dinitroacridine derivatives; tetracyanoethylene; 2,4,8-trinitrothioxanthone; dinitrobenzene; dinitroanthracene; dinitroacridine; succinic anhydride; maleic anhydride; dibromomaleic anhydride; and the like.

As the binder resin material, as described above, the resin material of 9% or more and 29% or less in deformation at yield is used. When the binder resin material having the deformation at yield in this range is used, film abrasion of the photosensitive layer 12 is suppressed. When the deformation at yield is less than 9%, the film of the photosensitive layer 12 is liable to abrade, and when the deformation at yield exceeds 29%, an image defect or the like due to a deposited matter is liable to occur.

As the binder resin material of 9% or more and 29% or less in deformation at yield, it is possible to use resin materials such as a polycarbonate resin material, a polyester resin material and polyarylate resin material. However, from the viewpoints of compatibility with the hole transporting agent and the electron transporting agent, the polycarbonate resin material may preferably be used.

As the polycarbonate resin material, for example, it is possible to cite a polycarbonate resin material having a recurring unit represented by any one of the following chemical formulas (1) to (3). Other polycarbonate resin materials having recurring units different from the following recurring units may also be used.

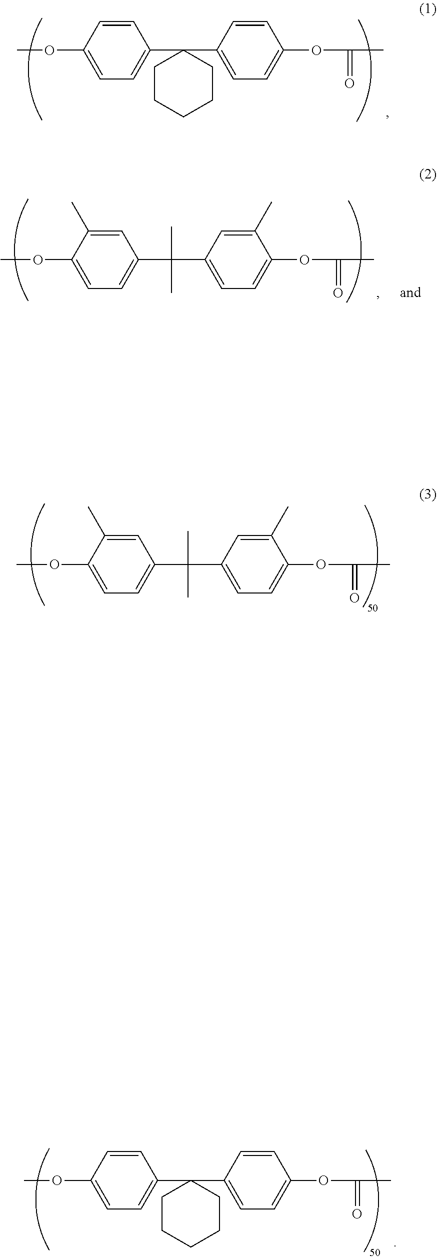

In the chemical formula (3), a numeral “50” represents that the binder resin material is copolymerized with a copolymerization ratio of 50%. Specifically, the polycarbonate resin material having the recurring unit represented by the chemical formula (3) shows that the polycarbonate resin material is a resin material prepared by copolymerization of the recurring unit represented by the chemical formula (1) and the recurring unit represented by the chemical formula (2) with the copolymerization ratio of 50%. Further, the number of recurring units in the polycarbonate resin material is not particularly limited, but may preferably be the recurring unit number such that the deformation at yield is 9% or more and 29% or less.

In the case where the polycarbonate resin material is used as the binder resin material, a viscosity-average molecular weight thereof may only be required to be 30000 or more. This is because when the viscosity-average molecular weight of the polycarbonate resin material is excessively low, it is difficult to enhance anti-wearing property of the polycarbonate resin material, so that there is a tendency that the photosensitive layer 12 is liable to abrade. However, when the viscosity-average molecular weight of the polycarbonate resin material is excessively high, the polycarbonate resin material is not readily dissolved in a solvent, so that an application liquid or the like for forming the photosensitive layer 12 is not readily prepared or the like, and thus there is a tendency that it becomes difficult to form a suitable photosensitive layer 12. Therefore, the viscosity-average molecular weight may preferably be 40000 or more and 80000 or less, more preferably be 55000 or more and 75000 or less.

Incidentally, as the binder resin material, the polycarbonate resin material may preferably be used, but the binder resin material may also contain a resin material other than the polycarbonate resin material. As the resin material other than the polycarbonate resin material, it is possible to cite thermoplastic resin materials styrene resin materials such as a styrene-butadiene copolymer, a styrene-acrylonitrile copolymer, a styrene-maleic acid copolymer, a styrene-acrylic acid copolymer, an acrylic copolymer, a polyethylene resin material, an ethylene-vinyl acetate copolymer, a chlorinated polyethylene, a polyvinyl chloride, a polypropylene resin material, an ionomer, a vinylchloride-vinylacetate copolymer, a polyester resin material, an alkyd resin material, a polyamide resin material, a polyurethane resin material, a polyarylate resin material, a polysulfone resin material, a diallyl phthalate resin material, a ketone resin material, a polyvinyl butyral resin material, a polyether resin material, and a polyester resin material; thermosetting resin materials such as a silicone resin material, an epoxy resin material, a phenolic resin material, an urea resin material, a melamine resin material, and other cross-linkable thermosetting resin materials; and photo-curable resin materials such as an epoxyacrylate resin material and an urethane-acrylate resin material.

Further, in addition to the charge generating agent, the charge transporting agent and the binder resin material, various additives may also be contained in the photosensitive layer 12 within a range in which the additives have no influence on an electrophotographic characteristic. As the additives, it is possible to cite antidegradents such as an antioxidant, a radical scavenger, a singlet quencher, and an ultraviolet absorber; a softener; a plasticizer; a surface modifier; an extender; a thickener; a dispersion stabilizer; a wax; an acceptor; a doner; a surfactant; a leveling agent; and the like. Further, in order to improve sensitivity of the photosensitive layer 12, for example, a known sensitizer such as terphenyl, halonaphthoquinones, acenaththylene, and the like may also be used in combination with the charge generating agent.

In this embodiment, an application (coating) liquid is prepared by mixing and dispersing 5 wt. parts of the charge generating agent 50 wt. parts of the hole transporting agent (HTM-3), 35 wt. parts of the electron transporting agent (ETM-2), 100 wt. parts of the binder resin material (viscosity-average molecular weight: 67000) and 800 wt. parts of tetrahydrofran for 50 hours in a ball mill. Then, this application liquid is applied onto the electroconductive substrate by dip coating, followed by hot air drying at 100° C. for 40 minutes, so that a 30 μm-thick photosensitive layer 12 is formed.

### <Charging Roller>

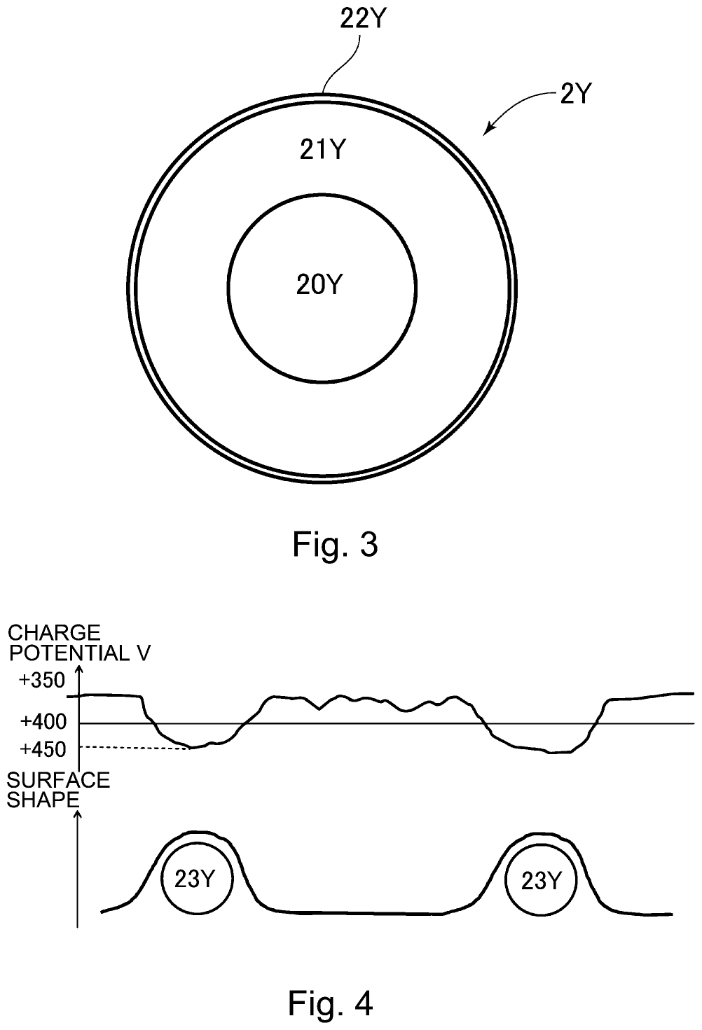

Next, the charging roller 2Y will be described using FIG. 3. As shown in FIG. 3, the charging roller 2Y is a rubber roller including a core metal 20Y, a base layer 21Y which is an electroconductive rubber layer, and a surface layer 22Y. In the case of this embodiment, the charging roller 2Y is formed so that volume resistivity is 10⁵ Ω·cm or more and 10⁷ Ω·cm or less. A chrome-plated iron was used as a material of the core metal 20Y, a hydrin rubber was used as a material of the base layer 21Y, and a nylon resin material-based material was used as a material of the surface layer 22Y. As the base layer 21Y, a layer of 62° or more and 81° or less in Asker-C hardness was used. Further, the surface layer 22Y is formed by coating the base layer 21Y with paint in which nylon resin material particles are mixed, and in order to change surface roughness of the charging roller 2Y, a diameter of the nylon resin material particles is changed. The surface of the charging roller 2Y is formed so that a ten point average roughness (Rz: JIS roughness standard B0601 ('82)) is 20 μm or more and 35 μm or less and an average interval (spacing) of unevenness (Sm: JIS roughness standard B0601 ('82)) is 130 μm or more and 250 μm or less. In this embodiment, as an example, the charging roller 2Y was formed so that the surface roughness (Rz) is 22 μm and the average interval (Sm) is 150 μm.

Incidentally, the surface roughness (Rz) and the average interval (Sm) of the charging roller 2Y are values obtained by measuring the surface of the charging roller 2Y with respect to a rotational axis direction, and were measured under the following condition with use of a surface roughness meter (“SURFCOM 480 (contact type)”, manufactured by TOKYO SEIMITSU CO., LTD.). A measuring point is one point which is a longitudinal center point, vertical magnification is 2000, horizontal magnification is 50, cut-off kc is 0.8 mm, a measuring length is 4.0 mm, and a feeding speed is 0.3 mm/s.

Incidentally, in the case where the photosensitive drum 1Y including a single photosensitive layer 12 is electrically charged by a DC charging type in which only a DC voltage is applied to the charging roller 2Y, in a conventional constitution, thin density non-uniformity in a lateral stripe shape extending in a main scan direction (rotational axis direction of the photosensitive drum 1Y) occurred in the image in some instances. This is because due to electric discharge (downstream side discharge) intermittently generating in a charging gap between the photosensitive drum 1Y and the charging roller 2Y on a downstream side of the photosensitive drum 1Y with respect to a rotational direction, a part of the charged photosensitive drum 1Y is re-charged by electric discharge on an upstream side of the photosensitive drum 1Y with respect to the rotational direction. For example, in the case where rotational speeds of the photosensitive drum 1Y and the charging roller 2Y are slow, specifically in the cases of during sheet passing of thick paper, a low-speed machine, and the like, the above phenomenon is conspicuous.

Specifically, in the case where the photosensitive drum 1Y is not charged to a predetermined charge potential in the charging gap on the upstream side of the photosensitive drum 1Y with respect to the rotational direction, i.e., when a potential difference between the photosensitive drum 1Y and the charging roller 2Y in the downstream side charging gap is a discharge start voltage (Vth) or more, downstream side electric discharge generates. In the case of this embodiment, when a difference between the discharge start voltage (Vth) and the downstream side potential difference between the photosensitive drum 1Y and the charging roller 2Y is about 0 V, the density non-uniformity does not readily occur. However, in the case where the difference between the discharge start voltage (Vth) and the downstream side potential difference is small, the downstream side electric discharge occurs but does not occur intermittently, and therefore, charging non-uniformity can occur. In the case of this embodiment, the difference between the downstream side potential difference and the discharge start voltage (Vth) is 15 V, so that the density non-uniformity was conspicuous. Therefore, in order to suppress the density non-uniformity even when the downstream side electric discharge occurs, the downstream side electric discharge may only be required to be caused to occur intermittently and stably by increasing the downstream side potential difference. That is, it may only be required that the downstream side potential difference is sufficiently larger than the discharge start voltage (Vth). In the case of this embodiment, the difference between the downstream side potential difference and the discharge start voltage (Vth) is 30 V or more, so that the density non-uniformity was capable of being suppressed. Therefore, in order to make the difference between the downstream side potential difference and the discharge start voltage (Vth) 30 V or more, a discharging device (pre-exposure device) capable of electrically discharging the surface of the photosensitive drum 1Y before the charging may only be required to be provided, but provision of the discharging device costs much and therefore is not readily employed. In the case where the discharging device is not provided, a pre-charging potential of the photosensitive drum 1Y can vary depending on a place, and therefore, in a conventional constitution, it is difficult to generate the downstream side electric discharge intermittently and stably, with the result that the above-described density non-uniformity occurs. Further, even in the case where the discharging device is provided, due to drum deterioration depending on a use (operation) period, a use environment (temperature and humidity) and the like of the photosensitive drum 1Y, the difference between the downstream side potential difference and the discharge start voltage (Vth) is less than 30 V, so that there was a liability that the density non-uniformity occurred.

Therefore, in this embodiment, in view of the above-described points, even when the downstream side electric discharge cannot be generated intermittently and stably, the surface roughness of the charging roller 2Y is made larger than a surface roughness in the conventional constitution, so that the place of the electric discharge is divided into a portion (projection) where the downstream side electric discharge with respect to the rotational axis direction generates and a portion (recess) where the downstream side electric discharge does not generate. For that purpose, in the case of this embodiment, the charging roller 2Y is formed so that the surface thereof has the ten point average roughness (Rz) of 20 μm or more and 25 μm or less.

In FIG. 4, a relationship between a surface shape (unevenness) of the charging roller 2Y with respect to the rotational axis direction and a charge potential of the photosensitive drum 1Y charged by the charging roller 2Y, in a minute range of unevenness of a toner size (μm order) is shown. Here, the surface roughness (Rz) of the charging roller 2Y is 22 μm was shown. Incidentally, in the figure, nylon resin material particles 23Y having the influence on the surface roughness of the charging roller 2Y are illustrated for convenience. As shown in FIG. 4, a target charge potential is +400 V, but at projections of the surface of the charging roller 2Y, the electric field is liable to concentrate and therefore the target charge potential is +450 V, and at recesses (non-projections) of the surface of the charging roller 2Y, the target charge potential is +350 V.

The present inventors conducted an experiment in which halftone images were formed while changing the surface roughness (Rz) of the charging roller 2C at the image forming portion PC and then the influence thereof on density non-uniformity (lateral stripe in this case) was checked. In the experiment, a copying machine (“image RUNNER ADVANCE 3330”, manufactured by Canon Inc.) was used. The pre-charging potential of the photosensitive drum 1C was measured by an electrostatic voltmeter (“Model 344”, manufactured by TREK JAPAN). The surface shape of the charging roller 2C was measured using a scanning probe microscope (SPM). As the SPM, there are an atomic force microscope, Kelvin force microscope and the like.

In each of the cases of 22 μm in surface roughness (Rz) as this embodiment and the cases of 12 μm and 19 μm in surface roughness (Rz) as comparison examples, the experiment was conducted while changing a secondary color toner amount and the pre-charging potential. The discharging device is not provided. An experiment result is shown in Table 1. In Table 1, in descending order of a degree of the density non-uniformity of the image, evaluation results are represented by two crosses (xx), one cross (x), triangle (Δ), circle () and double circle (⊚). Incidentally, a “upstream station secondary color toner amount” is a toner weight density varying depending on whether or not solid patch images are formed at the image forming portions PY and PM positioned upstream of the image forming portion PC. In the case where the solid patch in image is formed only at the image forming portion PY, the secondary color toner amount is “100%”, and in the case where the solid patch images are formed at both the image forming portions PY and PM, the secondary color toner amount is “200%”. Incidentally, in the case where the solid patch image is not formed at either of the image forming portions PY and PM, the secondary color toner amount is “0%”.

TABLE 1

| ITEMS | USSCTA*¹ | PBC*² | SR*³ Rz (μm) | LS*⁴ |
|---|---|---|---|---|
| COMP. EX. 1 | 100% | +200 | 12 | X |
| COMP. EX. 2 | 100% | +200 | 19 | Δ |
| THIS EMB. | 100% | +200 | 22 | ⊚ |
| COMP. EX. 3 | 200% | +390 | 12 | XX |
| COMP. EX. 4 | 200% | +390 | 19 | X |
| THIS EMB. | 200% | +390 | 22 | ◯ |

*¹“USSCTA” is an upstream station secondary color toner amount.
*²“PBC” is potential before charging.
*³“SR” is surface roughness.
*⁴“LS” is lateral stripe.

As can be understood from Table 1, compared with the cases of 12 μm and 19 μm in surface roughness (Rz) of the charging roller 2C, in the case of rough surface of 22 μm in surface roughness (Rz) of the charging roller 2C, it is understood that the density non-uniformity in the lateral stripe shape does not readily occur. That is, with a larger surface roughness (Rz), in other words, with a larger size of the nylon resin material particles (FIG. 4), division of the downstream side electric discharge is caused to be liable to occur, so that charging of the photosensitive drum 1C with respect to the main scan direction (rotational axis direction) with the downstream side electric discharge is divided. As a result, in the case where the downstream side electric discharge generates, the density non-uniformity can occur with respect to the main scan direction, but a portion where the density is relatively thin (where the downstream side electric discharge is weak) and a portion where the density is thick (where the downstream side electric discharge is strong) exist in mixture, so that the density non-uniformity can be suppressed to the extent that the density non-uniformity cannot be discriminated on the image. In other words, with respect to the main scan direction, the portion where the density is thin can be reduced more than the conventional constitution. However, when the surface roughness (Rz) of the charging roller 2Y is made excessively large, there is a liability that with respect to the main scan direction, the portion where the density is thick is rather conspicuous. Therefore, in this embodiment, the surface of the charging roller 2Y is formed so that the ten point average roughness (Rz) is 20 μm or more and 35 μm or less.

As described above, in this embodiment, by using the charging rollers 2Y to 2K each having the surface roughness (Rz9 of 20 μm or more and 35 μm or less, the photosensitive drums 1Y to 1K each having the single photosensitive layer 12 are electrically charged. As a result, as described above, the electric discharge can be divided into the portion (projection) where the downstream side electric discharge with respect to the main scan direction (rotational axis direction) generates and the portion (recess) where the downstream side electric discharge with respect to the main scan direction (rotational axis direction) does not generates, with the result that the density non-uniformity can be suppressed to the extent that the density non-uniformity cannot be discriminated on the image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-179900 filed on Sep. 26, 2018, which is hereby incorporated by reference herein in its entirety.

What is claimed is:

1. An image forming apparatus comprising:
a photosensitive member including a substrate and a single photosensitive layer formed on said substrate and containing a charge generating agent, a charge transporting agent and a binder resin material;
a charging roller configured to electrically charge said photosensitive member in contact with said photosensitive member under application of only a DC voltage; and
an image forming portion configured to form an electrostatic latent image on said photosensitive member charged by said charging roller and then to form a toner image on a recording material on the basis of the formed electrostatic latent image,
wherein said charging roller includes an electroconductive rubber layer and is 20 μm or more and 35 μm or less in ten point average roughness of a surface thereof and 130 μm or more and 250 μm or less in average interval of surface unevenness.

2. An image forming apparatus according to claim 1, wherein said binder resin material is a resin material of 9% or more and 29% or less in deformation at yield.

3. An image forming apparatus according to claim 1, wherein said binder resin material is a resin material of 55000 or more and 75000 or less in viscosity-average molecular weight.

4. An image forming apparatus according to claim 1, wherein said binder resin material is a polycarbonate resin material.

5. An image forming apparatus according to claim 1, wherein said binder resin material is a polycarbonate resin material having a recurring unit represented by any one of the following chemical formulas (1) to (3): 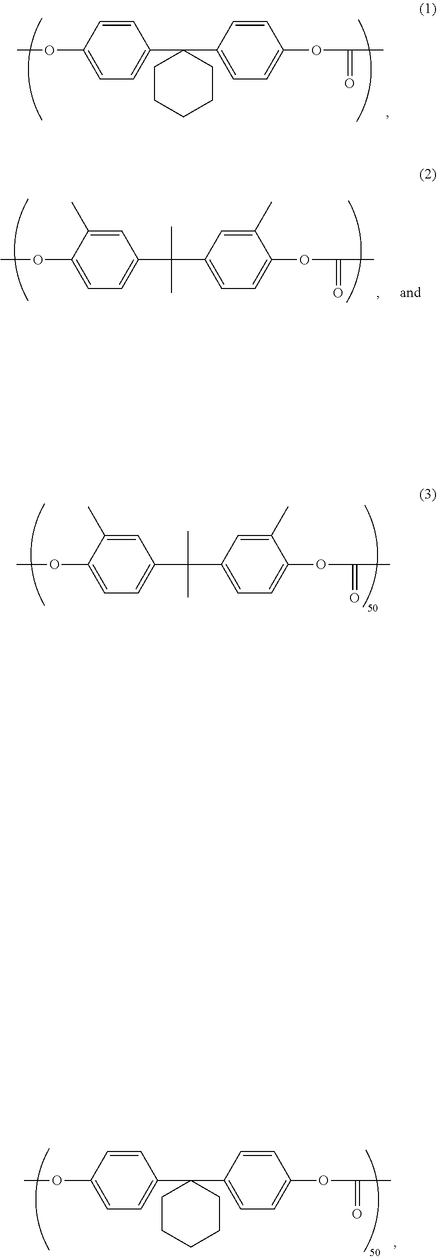
where a numeral 50 in the chemical formula (3) represents that the polycarbonate resin material is copolymerized with a copolymerization ratio of 50%.

6. An image forming apparatus according to claim 1, wherein said charging roller includes a surface layer on said rubber layer.

7. An image forming apparatus according to claim 1, wherein said charging roller is 10⁵ Ω·cm or more and 10⁷ Ω·cm or less in volume resistivity.

8. An image forming apparatus according to claim 1, wherein said rubber layer of said charging roller is 62° or more and 81° or less in Asker-C hardness.

9. An image forming apparatus according to claim 1, wherein said photosensitive member is 0.2 μm or more and 2.0 μm or less in ten point average roughness of a surface thereof.
